(19) United States
(12) Patent Application Publication
(10) Pub. No.: US 2006/0238459 A1
(43) Pub. Date: Oct. 26, 2006

(54) Date driver circuit of display device

(75) Inventor: Hui-Ya Huang, Tainan Hsien (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 11/407,189

(22) Filed: Apr. 20, 2006

(30) Foreign Application Priority Data
Apr. 22, 2005 (TW) 94112906

(51) Int. Cl. G09G 3/30

(52) U.S. Cl. 345/76

(57) ABSTRACT

A data driving circuit, used to drive display devices, comprises: a digital-to-analog current converter for receiving a digital signal and further converting the digital signal to an analog current which is larger than a current for driving display units; and plural stages of data driver units connected to the digital-to-analog current converter, for driving a plurality of data lines of the display units. The data driver units further comprise sample-holding circuits and sample-holding switches.

### FIELD OF THE INVENTION

The present invention relates to a structure of a data driving circuit in a current driving display, and more specifically to a circuit that amplifies a current from a digital-to-analog converter to improve the performance of gray scale of the display.

### BACKGROUND OF THE INVENTION

The organic electroluminescence display, known as the organic light emitting diode (OLED) display, is nearly applied to replace the traditional liquid crystal display (LCD) for its superiority in high brightness, fast response time, light weight, compactness, full color, wide view angle range, and low power consumption. The OLED display is also applied to serve the display devices as new generation portable electronic products, such as calculators, personal digital assistants (PDAs), laptops, digital cameras, and mobile phones.

The OLED is a current driving device whose light intensity is depended on the passing current. Currently, OLEDs fabricated in the organic electroluminescence display are disposed in array, and the image signals with different gray scales are obtained by adjusting the driving current of the OLEDs. To drive the OLEDs for generating the image, two types of designs, including a passive matrix and an active matrix, are applied. In the art, the active matrix is preferable for it can meet the requirements of a large-scale panel and can provide a higher resolution.

As shown in FIG. 1, an integrated driving circuit in the current driving display of the prior art is illustrated. The integrated driving circuit is applied to drive a pixel array 100 and comprises a level shifter 112, a digital-to-analog current converter 114 called as a DAC hereinafter, a horizontal shift register 116, a plurality of data driver units 118 and a vertical shift register 120. The data driver units 118 include a plurality of sample-holding switches SW₁-SW_{N} (called as S/H switches hereinafter) and a plurality of sample/holding circuits S/H₁-S/H_{N} (called as S/H circuits hereinafter), wherein the first S/H circuit S/H₁ can store or output data to the pixels 11, 12, . . . in column 1 when the S/H switch SW₁ is switched on or off, respectively. Similarly, the pixels 21, 22 . . . in column 2 are driven by the S/H switch SW₂ and the S/H circuit S/H₂, and similar operations occurs for the other S/H switches and the respective S/H circuits.

When the level shifter 112 receives a digital signal, the level shifter 112 adjusts the voltage level of the digital signal and then outputs it to the DAC 114 for converting the digital signal into an analog signal. Then, the horizontal shift register 116 outputs signals swₐ, sw_{b}, . . . , and swₙ respectively to the SW₁, SW₂, . . . , SW_{N} so as to have the analog signal stored into the S/H₁, S/H₂, . . . , S/H_{N} in turn. When one row N of pixels receive a scanning signal and the S/H circuit S/H_{N} outputs the analog signal to the pixels in column N, the pixel (N, N) is then driven by the analog signal from the S/H circuit S/H_{N}. When the DAC 114 receives the same digital signal of gray scale and converts it into the analog signal, the data driver units 118 can then receive the analog signal outputted from the DAC 114 and thereby the uniformity of the images quality can be enhanced.

However, there is a serious defect of the integrated driving circuit structure in the current driving display shown in FIG. 2. In practice, parasitical capacitors 124a, 124b . . . , 124n and parasitical resistors 122a, 122b . . . , 122n are inevitably formed in the wiring, and they can degrade the performance of gray scale to some extent. The end of the DAC 114 is used to store the electric charge due to the parasitical capacitors. The farther the distance from the DAC 114 is, the larger the capacitance of the parasitical capacitor can be. Yet, at the same time, the worse performance of the gray scale will be present. Furthermore, when the display shows the low gray scale immediately after the high gray scale, the influence on the performance of gray scale would be the worst. When the input signal is the high gray scale, the end of the DAC 114 would store the electric charges in the wire due to the parasitical capacitor. After that, the input signal is changed into the low gray scale and the value of the analog current converted from the DAC 114 is small. Normally, the display cannot show the low gray scale easily because the small current is unable to charge or discharge the voltage at the end of the DAC 114 on time.

Please refer to FIG. 3 which shows how the parasitical capacitors influence the integrated driving circuit while the low gray scale comes immediately after the high gray scale. In the figure, images of a testing of reciprocally showing the high gray scale and the low gray scale are used to illustrate the defect caused by the parasitical capacitor. In subplot A, according to the scan direction from left to right, three blocks are seen to represent the low gray scale, the high gray scale, and the low gray scale, respectively. In the reign of the right-hand-side low gray scale following the middle high gray scale, the electric charges in the parasitical capacitors close to the end of the DAC 114 would degrade the low gray scale by generating a gradient phenomenon as shown. Subplot B differs from subplot A by its scan direction, from right to left. Apparently, the parasitical capacitors influence the presentation of low gray scale by generating the gradient phenomenon at the reign of the low gray scale following the high gray scale. In subplot C of FIG. 3, there are three blocks to illustrate the leading high gray scale, the following low gray scale, and the later high gray scale and the scan direction is from left to right. At the reign of the low gray scale following the leading high gray scale, the end of the DAC 114 stored the electric charges by the parasitical capacitors causes a non-expectative presentation of low gray scale (i.e., a gradient phenomenon). Subplot D is similar to subplot C, but the scan direction is altered from right to left. Again, the parasitical capacitors influence obviously the presentation of low gray scale by generating the gradient phenomenon at the reign of the low gray scale following the leading high gray scale.

Therefore, the object of the present invention is to make the display to show the low gray scale expectative at the reign of the low gray scale following the high gray scale for overcoming the influence by the parasitical capacitors and the parasitical resistors of the circuit in the current driving display.

### SUMMARY OF THE INVENTION

The prime objective of the present invention is to improve the performance of display units in low gray scale. In the present invention, an analog current outputted from a digital-to-analog current converter (DAC) is amplified to be larger than the driving current of the display units so as to offset the influence of parasitical capacitors on low gray scale.

A data driving circuit is used to drive at least a display unit, and the display unit is coupled to the data driving circuit via a pixel circuit and a data line at least. The data driving circuit comprises a digital-to-analog current converter (DAC) and plural stages of data driver units. The DAC receives a digital signal and then converts the digital signal into a respective analog current, which the analog current is larger than the driving current of the display unit. The data driver units are connected to the DAC so as to drive the data lines of the display units. Each stage of the data driver units comprises a sample-holding circuit for copying or refreshing the analog current to a respective current signal that is further outputted to the data lines of display units, and a sample-holding switch connected between the DAC and the sample-holding circuit so as to control the corresponding stage of the data driver units in ON/OFF of storing or refreshing the analog current. In the present invention, the current signal is smaller than or equal to the analog current.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 illustrates an integrated data driving circuit structure in prior art;

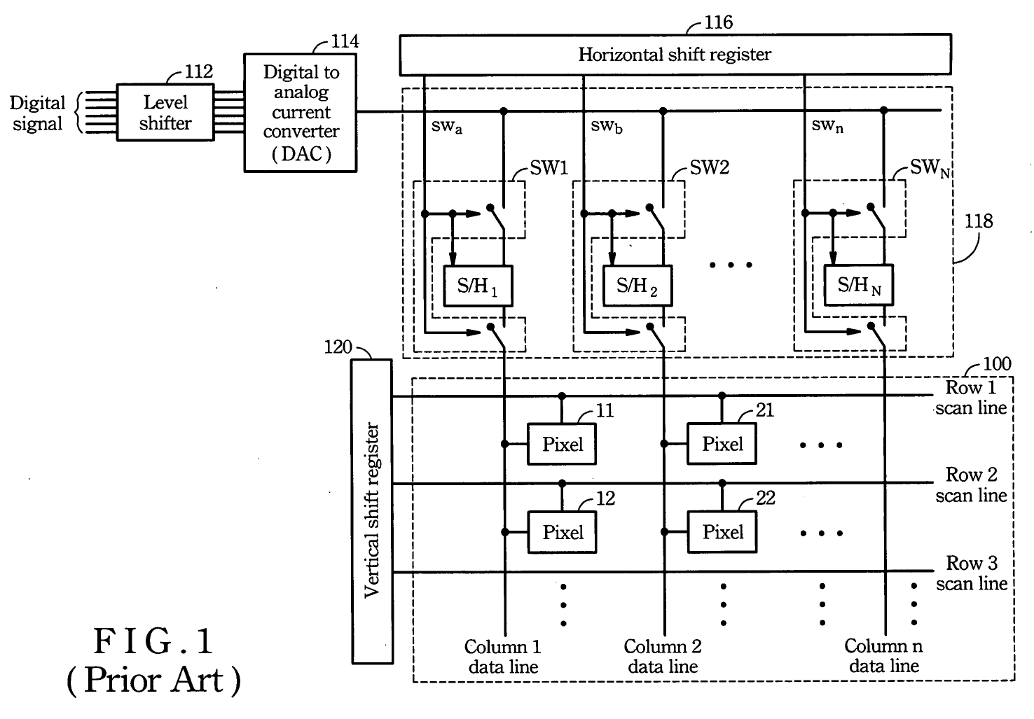

FIG. 2 illustrates an integrated data driving circuit structure comprising parasitical capacitors and parasitic resistors in prior art;

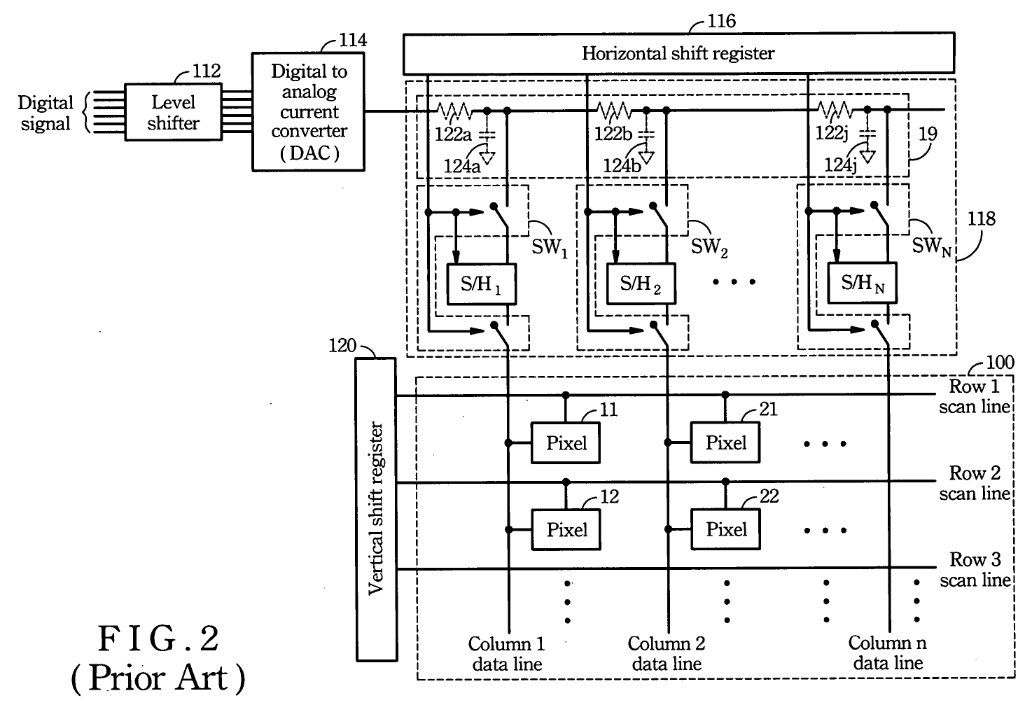

FIG. 3 illustrates how the parasitical capacitors influenced the integrated driving circuit in prior art;

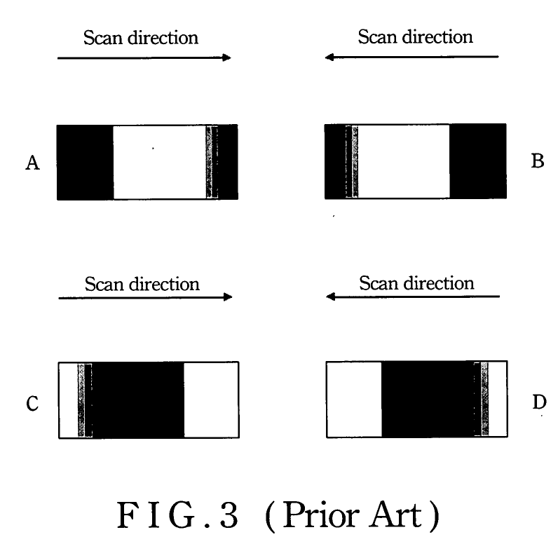

FIG. 4A illustrates one embodiment of a data driving circuit structure of the present invention;

FIG. 4B illustrates one embodiment of the DAC circuit structure of the present invention;

FIG. 5A˜C illustrates the relations between the gray scale current of a display unit and time in prior art; and

FIG. 6A˜C illustrates the relations between the gray scale current of a display unit and time of the present invention.

### DETAILED DESCCRIPTIONS OF THE PREFERRED EMBODIMENT

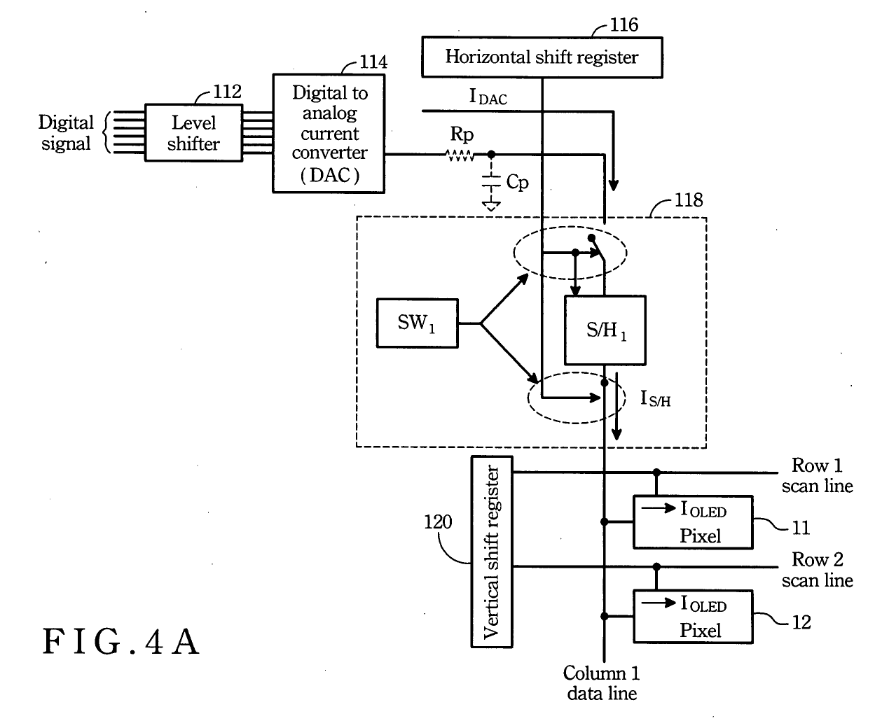

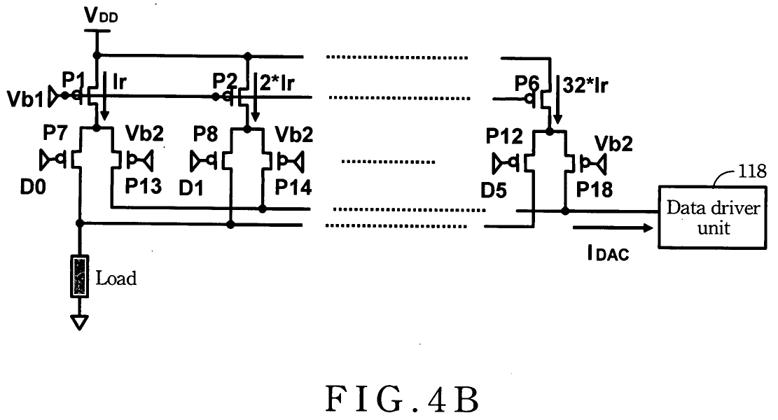

Please refer to FIG. 4A, which shows a preferred data driving circuit diagram according to the present invention. The data driving circuit is used to drive the pixel matrix (showing only one column of pixels). The data driving circuit includes a level shifter 112, a digital-to-analog current converter (DAC) 114, a horizontal shift register 116, plural stages of data driver units 118 (showing one of the stages), and a vertical shift register 120. The digital-to-analog current converter 114 can be a current steering type. Each stage of the data driver units includes a sample-holding switch SW_{N} and a sample-holding circuit S/H_{N}. A first column of the pixels 11, 12, . . . , and so on are controlled by the sample-holding switch SW₁ whom is switched on or off to permit the data stored or outputted to the sample-holding circuit S/H₁.

In this embodiment, the present invention is explained by using a 6-bit digital signal. Yet, to the skilled persons in the art, it should be understood that the range of the present invention is not restricted to such a 6-bit digital signal only. When the level shifter 112 receives a digital signal, the voltage (potential) of the digital signal is adjusted by the level shifter 112 and then outputted to the DAC circuit 114. The digital signal is converted and further amplified to an analog current I_{DAC} by the DAC circuit 114 so as to thereby overcome the influence of the storing electric charges on the parasitical resistors Rp and parasitical capacitors Cp in the end of DAC circuit 114. Then, the horizontal shift register 116 outputs a signal swₐ to control the switching of the sample-holding switch SW₁ to permit the analog current I_{DAC} to be stored into the sample-holding circuit S/H₁. The sample-holding circuit S/H₁ is then copied or refreshed from the analog current I_{DAC} to a current signal I_{S/H}. The current signal I_{S/H} is then output to the pixel 11 on a first row which receives the scan signal from the vertical shift register 120 to drive the pixel 11. The driving current I_{OLED}, produced from the pixel circuit, is used to drive the pixel 11 and to improve gray scales.

Each of the sample-holding circuits and the pixel circuits includes a current mirror made up by at least two transistors. By adjusting the width to length ratio (W/L) of the channel in the transistors, the current signals I_{S/H} and the driving currents I_{OLED} can be outputted smaller or changeless. The current mirror of the pixel circuit for reducing the driving current I_{OLED} that is inputted to the display unit so as to prevent the current signal I_{S/H} too big to burn the display unit in the case that the current signal I_{S/H} is equal to the analog current I_{DAC}.

Please refer to FIG. 4B, which shows a digital-to-analog current converter circuit of one embodiment according to the present invention. Transistors P1 to P6 are used to produce reference currents corresponding to the lowest bit D₀ to the highest bit D5, respectively. All of the six transistors are driven by the same bias voltage Vb1, and the width to length ratios (W/L) of the channel in the transistors increase in a geometric progression way with respect to the positions of the bits. That to say that the value of the reference currents is ranged from the smallest current Ir (2⁰×Ir) to the biggest 32*Ir (2⁵×Ir).

The transistors P1 to P6 are connected respectively to the sources of transistors P7 to P12 and the sources of transistors P13 to P18, such that six groups of transistors are made to receive six bits of digital signals. In each group, the drain of the transistor Pn is connected to the source of the transistor Pn+6 and the source of the transistor Pn+12. The transistors P7 to P12 received the lowest bit D₀ to the highest bit D₅ respectively for driving the transistors P7 to P12 to produce the currents collected into the load, and the transistors P13 to P18 are driven by the same bias voltage Vb2 to produce the remainder currents responsive to the currents from the transistors P7 to P12. The remainder currents are collected to an analog current I_{DAC} flowing from the DAC circuit into the data driver units 118.

In the DAC circuit of the present invention, the analog current I_{DAC} is amplified by increasing the width to length ratios (W/L) of the channel in the transistors P1 to P6 that produce the reference currents or by reducing the bias voltage Vb1.

There are many currents compositions that can be used in the present invention as following. Firstly, the analog current I_{DAC} is bigger than the current signal I_{S/H}, and the current signal I_{S/H} is bigger than the driving current I_{OLED}. Secondly, the analog current I_{DAC} is bigger than the current signal I_{S/H}, and the current signal I_{S/H} is equal to the driving current I_{OLED}. Thirdly, the analog current I_{DAC} is equal to the current signal I_{S/H}, and the current signal I_{S/H} is bigger than the driving current I_{OLED}. These three compositions all can overcome the electric charges of the parasitical resistors and parasitical capacitors in the end of the DAC circuit, and thereby the gray scale performance of the display can be improved.

A method for adjusting a data driving circuit to improve the gray scale performance of image comprises steps as follow. The analog current I_{DAC} is amplified by increasing width to length ratios of the channel in transistors or reducing the control voltage of transistors in the DAC circuit. The analog current I_{DAC} is inputted to plural stages of data driver units. The stages of data driver units are used to reduce the analog current I_{DAC} into the current signal I_{S/H}. The current signal I_{S/H} is inputted to drive a plurality of display units.

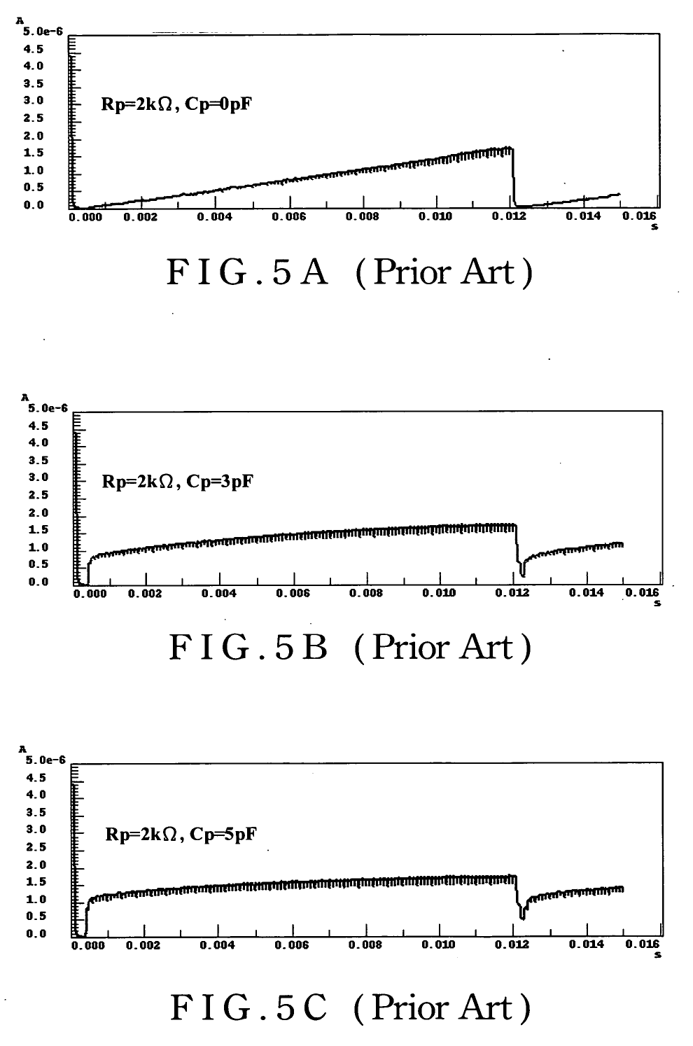

Please refer to FIG. 5, which shows the relationships between the gray scale current (in Ampere) of the display and time (in second) in the prior art. Without amplifying the analog current I_{DAC}, FIG. 5A illustrates the simulation of the conventional data driving circuit having the parasitical resistor Rₚ=2 kΩ without the parasitical capacitors, FIG. 5B illustrates the simulation of the conventional data driving circuit having the parasitical capacitor Cₚ=3 pF and the parasitical resistor Rₚ=2 kΩ, and FIG. 5C illustrates the simulation of the conventional data driving circuit having the parasitical capacitor Cₚ=5 pF and the parasitical resistor Rₚ=2 kΩ. As shown, when the circuit exists the parasitical resistors and the parasitical capacitors, the performance of gray scales are poor especially for the low gray scale following the high gray scale, and thus the discrimination between the gray scales is vague. Also, when the capacitance of the parasitical capacitors is larger, the low gray scales are more difficult to show expectably.

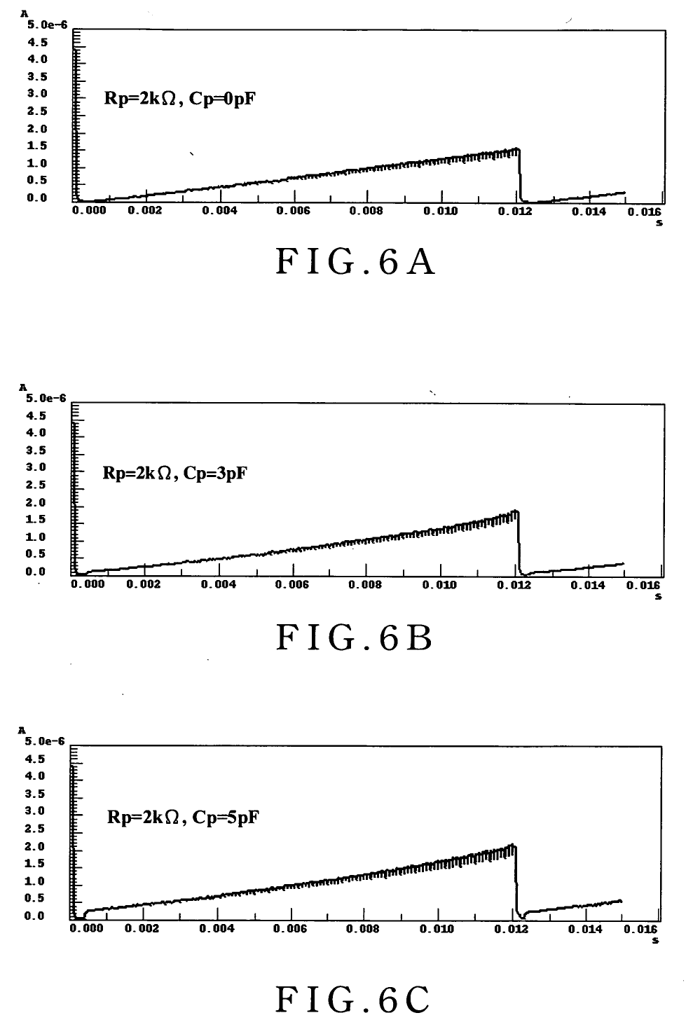

Please refer to FIG. 6, which shows the relationships between the gray scale current (in Ampere) of the display and time (in second) in the present invention. Under the analog current triple to that in FIG. 5, FIG. 6A illustrates the simulation of the data driving circuit having the parasitical resistor Rₚ=2 kΩ without the parasitical capacitors, FIG. 6B illustrates the simulation of the data driving circuit having the parasitical capacitor Cₚ=3 pF and the parasitical resistor Rₚ=2 kΩ, and FIG. 6C illustrates the simulation of the data driving circuit having the parasitical capacitor Cₚ=5 pF and the parasitical resistor Rₚ=2 kΩ. Compared FIG. 6 with FIG. 5, the results of the simulation provided by the present invention present a better performance of the gray scales while meeting the existence of the parasitic capacitors and the parasitical resistors in the circuit. At the low gray scale following the high gray scale, the discrimination of the gray scale is obvious even though the capacitance of the parasitical capacitor is Cₚ=5 pF. Apparently, amplifying the currents in the present invention can lessen the influence of the parasitical capacitors and the parasitical resistors in the circuit so as to show the low gray scale of the display expectably.

The analog current outputted from the DAC circuit is bigger than the driving current of the display units in the present invention so as to show a better performance of the low gray scales of the display. It can show that the discrimination of the gray scale, especially for the low gray scale following the high gray scale, is clear, and the gradient phenomenon like the conventional data driving circuit in the prior art is not shown in the present invention. The data driving circuit of the present invention can achieve the result of better performance in the low gray scale of the displays in all current driver displays.

Although the present invention and its advantages have been described in detail, as well as some variations over the disclosed embodiments, it should be understood that various other changes, substitutions and alterations can be made herein without departing from the spirit and scope of the invention as defined by the appended claims.

What is claimed is:

1. A data driving circuit, used to drive display units and connected to said display units via a plurality of pixel circuits and a plurality of data lines, comprising:
a digital-to-analog current converter for receiving a digital signal and further converting the digital signal into an analog current larger than a driving current for said display units; and
plural stages of data driver units, connected to said digital-to-analog current converter, for driving said data lines of said display units, and each of said stages of data driver units further comprising:
a plurality of sample-holding circuits used to copy or refresh current signals to said data lines wherein said current signal is smaller than or equal to said analog current; and
a plurality of sample-holding switches, connected to said digital-to-analog current converter and said sample-holding circuits, for controlling switching of said data driver units in storing or refreshing said analog current.

2. The data driving circuit of claim 1 further comprising a level shifter connected to said digital-to-analog current converter so as to adjust a voltage level of said digital signal.

3. The data driving circuit of claim 1 further comprising a shift register for outputting a plurality of switch signals to said sample/hold switches of said data driver units, wherein each of said switch signals is used to control said switching of said data driver units.

4. The data driving circuit of claim 1, wherein said display unit comprises an OLED, a PLED, or the other current driving display unit.

5. The data driving circuit of claim 1, wherein said digital-to-analog current converter comprises a current steering type.

6. The data driving circuit of claim 1, wherein said sample-holding circuit has a current mirror circuit for reducing said current signal to be smaller than or equal to said analog current.

7. The data driving circuit of claim 1, wherein said pixel circuit has a current mirror circuit for reducing said current signal that is inputted to said display unit so as to prevent said current signal too big to burn said display unit in the case that said current signal is equal to said analog current signal.

8. A method for adjusting a data driving circuit to improve the gray scale performance of image, comprising:
inputting an analog current to plural stages of data driver units;
using said stages of data driver units to reduce said analog current into a current signal; and
inputting said current signal to drive a plurality of display units.

9. The method for adjusting a data driving circuit of claim 8, wherein said analog current is transferred from a digital-to-analog current converter circuit.

10. The method for adjusting a data driving circuit of claim 9, further comprising:
amplifying said analog current by increasing width to length ratios of a channel in transistors of said digital-to-analog current converter circuit before “inputting an analog current to plurality stages of data driver units”.

11. The method for adjusting a data driving circuit of claim 9, further comprising:
amplifying said analog current by reducing a control voltage of transistors in said digital-to-analog current converter circuit before “inputting an analog current to plural stages of data driver units”.

12. The method for adjusting a data driving circuit of the claim 8, wherein “using said plural stages of data driver units to reduce said analog current into a current signal” is to adjust width to length ratios of a channel in transistors of a current mirror circuit in said data driver unit.

13. A method for adjusting a data driving circuit to improve the gray scale performance of image, comprising:
inputting an analog current to plural stages of data driver units;
using said plural stages of data driver units to reduce said analog current into a current signal; and
inputting said current signal to drive a plurality of display units; and
using pixel circuits to reduce said current signal to drive display units.

14. The method of claim 13, wherein said analog current is transferred from a digital-to-analog current converter circuit.

15. The method of claim 14, further comprising:
amplifying said analog current by increasing width to length ratios of a channel in transistors of said digital-to-analog current converter circuit before “inputting an analog current to plural stages of data driver unit”.

16. The method of claim 14, further comprising:
including a step of amplifying said analog current by reducing a control voltage of transistors in said digital-to-analog current converter circuit before “inputting an analog current to plural stages of data driver unit”.

17. The method of the claim 13, wherein “using pixel circuits to reduce said current signal to drive display units” is to adjust width to length ratios of a channel in transistors of a current mirror circuit in said data driver unit.
